(19) United States
(12) Patent Application Publication
(10) Pub. No.: US 2015/0076176 A1
(43) Pub. Date: Mar. 19, 2015

(54) DISPENSERS FOR NON-COLLAPSING CONTAINERS AND VENTING PUMPS

(71) Applicant: Eugene W. Ray, Barberton, OH (US)

(72) Inventor: Eugene W. Ray, Barberton, OH (US)

(73) Assignee: GOJO INDUSTRIES, INC., Akron, OH (US)

(21) Appl. No.: 14/484,328

(22) Filed: Sep. 12, 2014

Related U.S. Application Data
(60) Provisional application No. 61/877,616, filed on Sep. 13, 2013.

(51) Int. Cl. A47K 5/12; B05B 15/00; B05B 11/00

(52) U.S. Cl. CPC A47K 5/1211; B05B 11/3087; B05B 11/3061; B05B 11/3001; B05B 15/008
USPC 222/189.11; 222/383.1; 222/321.1

(57) ABSTRACT

Exemplary dispensers having non-collapsible containers and venting pumps are disclosed herein. Some exemplary dispensers include a rigid container for holding a liquid and a pump secured to the container. The pump has a liquid pump portion and an air pump portion. The liquid pump portion has a one-way liquid inlet valve, a liquid pump chamber and a liquid outlet valve. Expansion of the liquid chamber causes liquid to flow from the container past the liquid inlet valve into the pump chamber. Compression of the liquid chamber causes liquid to flow from the pump chamber past the liquid outlet valve. In addition, the air pump portion includes an air pump chamber, a piston, a one-way air inlet valve and a filter. Compression of the air pump chamber causes air to flow through the filter and past the one-way air inlet valve into the container.

This non-provisional utility patent application claims priority to and the benefits of U.S. Provisional Patent Application Ser. No. 61/877616 filed on Sep. 13, 2013 and entitled DISPENSERS FOR NON-COLLAPSING REFILL UNITS AND PUMPS. This application is incorporated herein by reference in its entirety.

### TECHNICAL FIELD

The present invention relates generally to liquid dispenser systems and more particularly to dispensers for non-collapsing containers, as well as venting pumps for use with such dispensers.

### BACKGROUND OF THE INVENTION

Liquid dispenser systems, such as liquid soap and sanitizer dispensers, provide a user with an amount of liquid upon actuation of the dispenser. It is desirable to provide such a dispenser having a rigid container that is vented with air so that the pump may re-prime itself after a dispensing action. It is also desirable to provide such a dispenser that is sanitarily sealed so that germs and bacteria do not enter the dispenser container.

### SUMMARY

Exemplary embodiments of dispensers with non-collapsible containers and venting pumps are disclosed herein. One exemplary dispenser includes a rigid container for holding a liquid and a pump housing secured to the container. The pump has a housing that has a first cylindrical wall and an annular liquid chamber defined at least in part by the first cylindrical wall, a one-way liquid inlet valve and a one-way liquid outlet valve. The pump housing includes an air chamber defined in part by first cylindrical wall, a second cylindrical wall and a one-way air inlet valve. The pump includes a liquid piston movable at least partially within the first cylindrical wall to expand and compress the annular liquid chamber and an air piston at least partially in contact with the outside of the first cylindrical wall and movable to expand and compress the air chamber. Movement of the liquid piston in a first direction draws liquid from the container into the liquid pump and movement of the liquid piston in the second direction causes liquid to be dispensed through an outlet; and movement of the air piston in the second direction causes air to flow into the container.

Another exemplary dispenser includes a rigid container for holding a liquid and a pump secured to the container. The pump has a liquid pump portion and an air pump portion. The liquid pump portion has a one-way liquid inlet valve, a pump chamber and a liquid outlet valve. Expansion of the liquid chamber causes liquid to flow from the container past the liquid inlet valve into the pump chamber. Compression of the liquid chamber causes liquid to flow from the pump chamber past the liquid outlet valve. The air pump portion includes an air pump chamber, a piston and a one-way air inlet valve. Compression of the air pump chamber causes air to flow past the one-way air inlet valve into the container.

Yet another exemplary dispenser includes a rigid container for holding a liquid and a pump secured to the container. The pump has a liquid pump portion and an air pump portion. The liquid pump portion has a one-way liquid inlet valve, a liquid pump chamber and a liquid outlet valve. Expansion of the liquid chamber causes liquid to flow from the container past the liquid inlet valve into the pump chamber. Compression of the liquid chamber causes liquid to flow from the pump chamber past the liquid outlet valve. In addition, the air pump portion includes an air pump chamber, a piston, a one-way air inlet valve and a filter. Compression of the air pump chamber causes air to flow through the filter and past the one-way air inlet valve into the container.

Yet another exemplary dispenser includes a rigid container for holding a liquid and a pump secured to the container. The pump has a liquid pump portion and an air pump portion. The liquid pump portion has a one-way liquid inlet valve, a liquid pump chamber and a liquid outlet valve. Expansion of the liquid chamber causes liquid to flow from the container past the liquid inlet valve into the pump chamber. Compression of the liquid chamber causes liquid to flow from the pump chamber past the liquid outlet valve. In addition, the air pump portion includes an air pump chamber, a piston and a filter. Compression of the air pump chamber causes air to flow through the filter and into the container.

In this way, a simple and economical air-vented liquid dispensers and venting pumps are provided.

### BRIEF DESCRIPTION OF THE DRAWINGS

These and other features and advantages of the present invention will become better understood with regard to the following description and accompanying drawings in which:

FIG. 1 is a partial cross-sectional view of a first exemplary embodiment of dispenser having a container and an inverted venting pump in a primed position;

FIG. 1A is an enlarged portion of the air inlet of the exemplary embodiment of FIG. 1;

FIG. 2 is a partial cross-sectional view of the exemplary embodiment of FIG. 1 with the venting pump in a partially discharged position with the air pump engaging the walls of the air chamber;

FIG. 3 is a partial cross-sectional view of the exemplary embodiment of FIG. 1 with the venting pump in a fully discharged position with the air pump engaging the walls of the air chamber; and

FIG. 4 is an exemplary embodiment of an upright dispenser with a venting pump.

### DETAILED DESCRIPTION

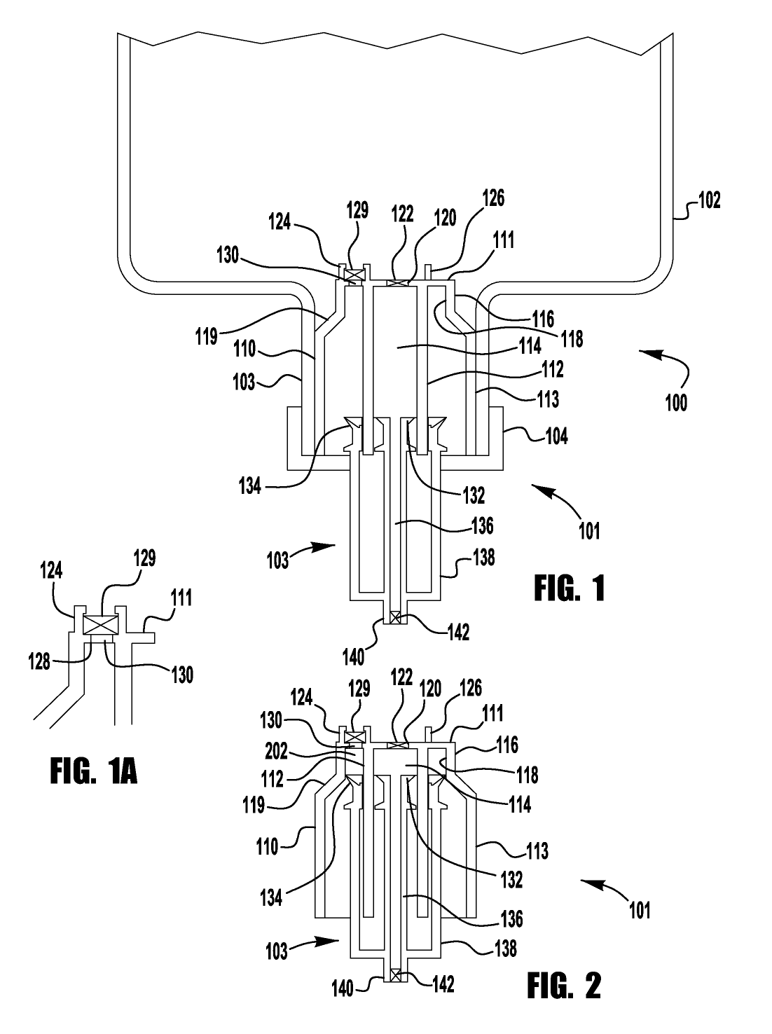

FIGS. 1 illustrates an exemplary embodiment of a sanitary sealed vented non-collapsible dispenser or refill unit 100. The dispenser 100 includes a container 102 a pump 101. Pump 101 has a pump housing 110 that has a cylindrical outside wall 113 that is secured in the neck 103 of container 102 by closure 104. Closure 104 may be secured to neck 103 by any means, such as, for example, a threaded connection, a snap-fit connection, a friction fit connection, a welded connection, an adhesive connection or the like. In addition, one or more gaskets (not shown) may be provided to ensure a liquid tight seal between container neck 103 and closure 104. Optionally, cylindrical outside wall 113 may be secured to the inside of the neck 103 of container 102 by any means such as, for example, a threaded connection, a snap-fit connection, a friction fit connection, a welded connection, an adhesive connection, or the like.

Pump housing 110 includes a base 111. A cylindrical pump chamber housing 112 extends downward from base 111. A cylindrical liquid intake shroud 126 extends upward from the base. A liquid inlet opening 120 is located in the base 111 providing a fluid path from the interior of container 102 to a liquid pump chamber 114 located at least partially within cylindrical pump chamber housing 112. A one-way liquid inlet valve 122 is located in opening 120. One-way liquid inlet valve 122 may be any type of one-way valve.

Pump housing 110 includes a cylindrical wall 116 projecting downward from base 111. A tapered wall 119 extends from cylindrical wall 116 to outside wall 113 which is secured to the neck of the container. The interior surface 118 of cylindrical wall 116 forms a portion of an air chamber. The volume of the air chamber may be increased or decreased by changing the length of cylindrical wall 116. Located in the base 111 is an air inlet opening 128 (FIG. 1A). A one-way air inlet valve 129 is located proximate opening 128 to allow air to enter container 102 but prevents air or liquid from exiting container 102. Inlet valve 129 is retained by projection 124 and a portion of intake shroud 126.

In some embodiments, a filter 130 is located in opening 128. The filter 130 may selected and sized to prevent mold and/or bacteria from passing into the container 102. Thus, when a filter 130 is used, the container 102 is a sanitary sealed container and bacteria and or mold may not enter container 102 through the air inlet opening. In some embodiments, filter 130 has a pore size is about 0.2 um. Such a pore size would provide an air input that is sterile and free of most viruses. In some embodiments the pore sized is about 0.45 um, which would provide an air input that is free of most bacteria. In some embodiments, the filet may be selected to filter out visible particles or particles in the mm size range. In addition, in some embodiments, a filter 130 has a MERV 5 or less range. In some embodiments, filter 130 has a rating of between about MERV 5 to about a MERV 8. In some embodiments filter 130 has a rating of MERV 5 or higher. Still yet, in some embodiments filter 130 has a rating of between about a MERV 9 to about a MERV 12. In some embodiments a rating of about MERV 13 or higher may used for filter 130.

In some embodiments, filter 130 is chosen to filter air, but is also chosen from a material that may get wet and still work okay. Such a filter is preferable in locations where a dispenser may be splashed with water, where the dispenser is located in a shower or where the dispenser is located in an area of high humidity. In addition, in some embodiments, an air inlet valve is not required when a wetable filter is used. In such embodiments, the wetable filter may have openings that allow air to pass through, but prevent liquid from passing out of the container. In one embodiment, the wetable filter is made of PTFE and has micro holes.

Pump 101 includes a piston 103. Piston 103 includes a hollow stem 136. Located at one end of hollow stem 136 is a wiper seal 132. Wiper seal 132 engages the side walls of cylindrical pump chamber housing 112. A one-way liquid outlet valve 142 is located near outlet 140 of hollow stem 136. A liquid pump chamber 114 is formed by hollow stem 136, wiper seal 132, cylindrical pump chamber housing 112, one-way liquid inlet valve 122 and one-way liquid outlet valve 142.

Piston 103 also includes air pump seal 134. Air pump seal 134 is located at the same position along piston 103 as liquid pump wiper seal 132. However, in some embodiments, air pump seal 134 is located higher then wiper seal 132 and in some embodiments, wiper seal 132 is located lower than wiper seal 132.

During operation, movement of piston 103 toward the container 102 compresses liquid pump chamber 114 and forces liquid from liquid pump chamber 114 through hollow stem 136 past one-way liquid outlet valve 142 where the liquid is dispensed through outlet 140. As piston 103 is moved away from container 102, liquid pump chamber 114 expands and liquid is drawn into liquid pump chamber 114 from container 102 past one-way liquid inlet valve 122. Piston 103 is moved upward and downward by an actuator or user. In some embodiments, a biasing member (not shown) such as, for example, a spring, is used to bias piston 103 outward so that the pump is normally in a primed position.

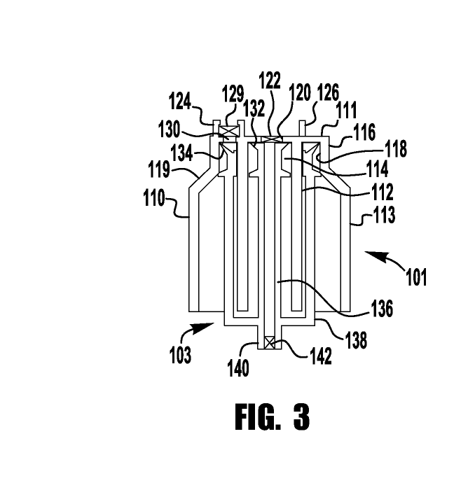

In addition, as piston 103 moves toward the container 102, air pump seal 134 engages the interior surface 118 of cylindrical wall 116, which is illustrated in FIG. 2. Once air pump seal 134 engages surface 118, further movement of piston 103 towards container 102 increases the pressure in air chamber 202. The pressurized air passes through filter 119 and one-way check valve 129 and flows into container 102 when the air chamber 202 is fully compresses as illustrated in FIG. 3. Thus, the container 102 is vented with filtered air and the interior of container 102 remains sanitary and free from bacteria or mold. In some embodiments, filter 119 is not needed or used.

As piston 103 moves away from container 102, air pump seal 134 deflects inward allowing air to flow past air pump seal 134 into air chamber 202. Once air pump seal 134 reaches tapered wall 119, air pump seal 134 loses contact with surface 118 and returns to its original shape.

In some embodiments air chamber 202 is sized so that the amount of air that passes through filter 119 and check valve 129 has substantially the same volume as the liquid that is removed from container 102. In some embodiments, the amount of air that passes through filter 119 and check valve 129 has a slightly larger volume than the volume of the liquid removed from container 102.

In some embodiments, the intake shroud 126 is sized to prevent air flowing through one-way check valve 129 to enter into pump chamber 114. In some embodiments, a tube (not shown) is connected to projection 124 (which may be an annular projection) and extends up into the container. Thus, the tube (not shown) would ensure that the air flowing into the container did not enter the pump chamber 114. In some embodiments, the tube is designed so that air bubbles form in the liquid, particularly if the liquid is a gel. Such an embodiment may increases the “fresh” look for products that are intentionally manufactured with bubbles in the liquid gel.

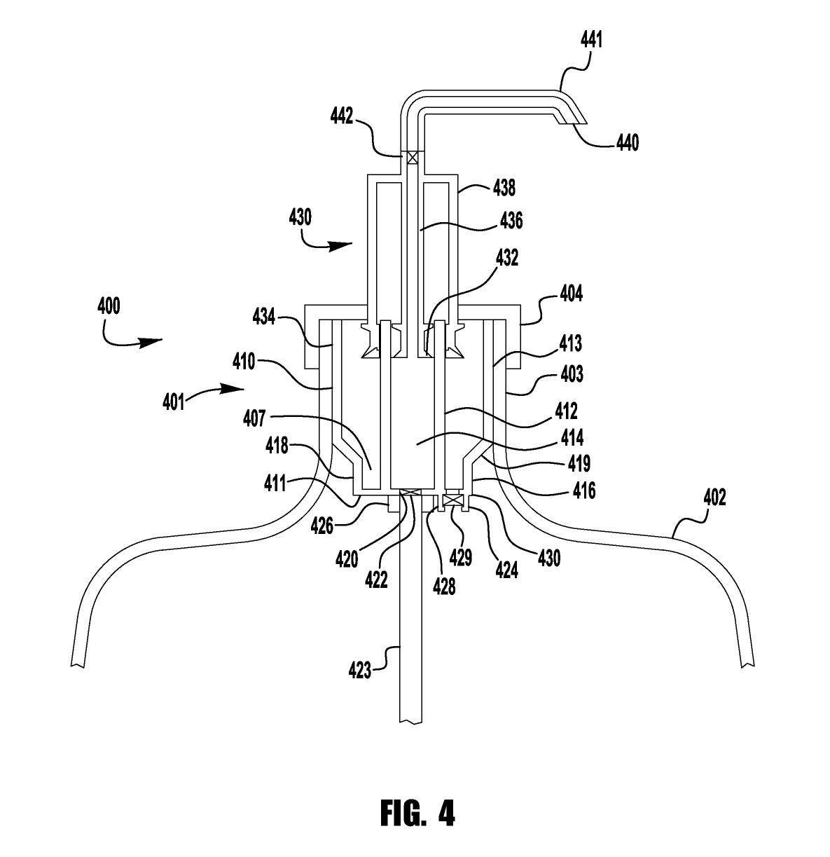

FIG. 4 illustrates an exemplary embodiment of an upright sanitary sealed vented non-collapsible dispenser or refill unit 400. The dispenser 400 includes a container 402 a pump 401. Pump 401 has a pump housing 410 that has a cylindrical outside wall 413 that is secured in the neck 403 of container 402 by closure 404. Closure 404 may be secured to neck 403 by any means, such as, for example, a threaded connection, a snap-fit connection, a friction fit connection, a welded connection, an adhesive connection or the like. In addition, one or more gaskets (not shown) may be provided to ensure a liquid tight seal between container neck 403 and closure 404. Optionally, cylindrical outside wall 413 may be secured to the inside of the neck 403 of container 402 by any means such as, for example, a threaded connection, a snap-fit connection, a friction fit connection, a welded connection, an adhesive connection, or the like.

Pump housing 410 includes a base 411. A cylindrical pump chamber housing 412 extends upward from base 411. Annular projection 426 extends downward from base 411 and is used to secure dip tube 423 in place. Dip tube 423 extends down to about the bottom of container 402. A liquid inlet opening 120 is located in the base 411 providing a fluid path from the interior of container 402, through dip tube 423 and to a liquid pump chamber 414 located at least partially within cylindrical pump chamber housing 412. A one-way liquid inlet valve 422 is located in opening 420. One-way liquid inlet valve 422 may be any type of one-way valve.

Pump housing 410 includes a cylindrical wall 416 projecting upward from base 411. A tapered wall 419 extends from cylindrical wall 416 to outside wall 413 which is secured to the neck of the container. The interior surface 418 of cylindrical wall 416 forms a portion of an air chamber. The volume of the air chamber may be increased or decreased by changing the length of cylindrical wall 418. Located in the base 411 is an air inlet opening 428. A one-way air inlet valve 429 is located proximate opening 428 to allow air to enter container 402 but prevents air or liquid from exiting container 402. Inlet valve 429 is retained by annular projection 424. In some embodiments, a tube (not shown) is retained by annular projection 424 and extends at least partially down into container 402 to inject the air into the liquid in the container 402. In some embodiments the tube (not shown) is coaxial with dip tube 423 and extends down into the container for a distance that is less than the distance the dip tube 423 extends into the container. In some embodiments, such as for example, embodiments where the liquid is a gel, it may be desirable to have the air form bubbles in the gel.

In some embodiments, a filter 430 is located in opening 428. The filter 430 may selected and sized as described above.

Pump 401 includes a piston 403. Piston 403 includes a hollow stem 436. Located at one end of hollow stem 436 is a wiper seal 432. Wiper seal 432 engages the side walls of cylindrical pump chamber housing 412. A one-way liquid outlet valve 442 is located near outlet 440 of hollow stem 436. A liquid pump chamber 414 is formed by hollow stem 436, wiper seal 432, cylindrical pump chamber housing 412, one-way liquid inlet valve 422 and one-way liquid outlet valve 442. A spout 441 is secured to hollow stem 436. Spout 441 has a liquid outlet 440 positioned and located to dispense liquid on a user's hand.

Piston 403 also includes air pump seal 434. Air pump seal 434 is located at the same position along piston 403 as liquid pump wiper seal 432. However, in some embodiments, air pump seal 434 is located higher then wiper seal 432 and in some embodiments, wiper seal 432 is located lower than wiper seal 432.

During operation, movement of piston 403 toward the container 402 compresses liquid pump chamber 414 and forces liquid from liquid pump chamber 414 through hollow stem 436 past one-way liquid outlet valve 442 where the liquid is dispensed through outlet 440 in spout 441. As piston 403 is moved away from container 402, liquid pump chamber 414 expands and liquid is drawn into liquid pump chamber 414 from container 402 past one-way liquid inlet valve 422. Piston 403 is moved upward and downward by an actuator or a user. In some embodiments, a biasing member (not shown) such as, for example, a spring, is used to bias piston 403 upward so that the pump is normally in a primed position and a user need only push down on the spout 441 to obtain a dose of liquid.

In addition, as piston 403 moves toward the container 402, air pump seal 434 engages the interior surface 418 of cylindrical wall 416, similar to that illustrated in FIG. 2. Once air pump seal 434 engages surface 418, further movement of piston 403 towards container 402 increases the pressures air in air chamber 407. The pressurized air passes through filter 419 and one-way check valve 429 and flows into container 402 from air chamber 407. Thus, the container 402 is vented with filtered air and the interior of container 402 remains sanitary and free from bacteria or mold. In some embodiments, the filter 419 is not needed.

As piston 403 moves away from container 402, air pump seal 434 deflects inward allowing air to flow past air pump seal 434 into air chamber 407. Once air pump seal 434 reaches tapered wall 419, air pump seal 434 loses contact with surface 418 and returns to its original shape.

In some embodiments air chamber 407 is sized so that the amount of air that passes through filter 419 and check valve 429 has substantially the same volume as the liquid that is removed from container 402. In some embodiments, the amount of air that passes through filter 419 and check valve 429 has a slightly larger volume than the volume of the liquid removed from container 402.

The term dispenser as used herein includes standalone dispensers and dispensers that may be considered as refill units that are installed in dispenser housings, such as a manual or touch free dispenser housings.

While the present invention has been illustrated by the description of embodiments thereof and while the embodiments have been described in considerable detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative apparatus and illustrative examples shown and described. Accordingly, departures may be made from such details without departing from the spirit or scope of the applicant's general inventive concept.

We claim:

1. A dispenser comprising:
a rigid container for holding a liquid;
a pump housing secured to the container;
the pump housing having a first cylindrical wall and an annular liquid chamber defined at least in part by the first cylindrical wall, a one-way liquid inlet valve and a one-way liquid outlet valve;
the pump housing having an air chamber defined in part by first cylindrical wall, a second cylindrical wall and a one-way air inlet valve;
a liquid piston movable at least partially within the first cylindrical wall to expand and compress the annular liquid chamber;
an air piston at least partially in contact with the outside of the first cylindrical wall and movable to expand and compress the air chamber;
wherein movement of the liquid piston in a first direction draws liquid from the container into the liquid pump and movement of the liquid piston in the second direction causes liquid to be dispensed through an outlet; and
movement of the air piston in the second direction causes air to flow into the container.

2. The dispenser of claim 1 further comprising a filter for filtering the air prior to the air being forced into the container.

3. The dispenser of claim 1 wherein the second cylindrical wall is shorter than the first cylindrical wall.

4. The dispenser of claim 1 wherein the air chamber is sized so that the volume of air forced through the one-way air inlet valve during movement in the second direction is substantially equivalent to the volume of liquid drawn through the one-way liquid inlet valve during movement in the first direction.

5. The dispenser of claim 1 wherein the air chamber is sized to create a positive pressure in the container.

6. The dispenser of claim 1 wherein the air chamber is sized to create a negative pressure in the container.

7. The dispenser of claim 1 wherein the liquid piston and the air piston comprise wiper seals.

8. The dispenser of claim 1 wherein the air piston and the liquid piston are connected together.

9. The dispenser of claim 1 wherein the seal of the air piston allows air to pass into the air chamber during expansion of the air chamber.

10. The dispenser of claim 1 further comprising a second one-way air valve to allow air to enter the air chamber.

11. The dispenser of claim 1 wherein the liquid is a soap or sanitizer.

12. A dispenser for a liquid comprising:
a rigid container for holding a liquid;
a pump secured to the container;
the pump having a liquid pump portion and an air pump portion;
the liquid pump portion having a one-way liquid inlet valve; a pump chamber and a liquid outlet valve;
wherein expansion of the liquid chamber causes liquid to flow from the container past the liquid inlet valve into the pump chamber;
wherein compression of the liquid chamber causes liquid to flow from the pump chamber past the liquid outlet valve;
the air pump portion includes an air pump chamber, a piston and a one-way air inlet valve;
wherein compression of the air pump chamber causes air to flow past the one-way air inlet valve into the container.

13. The dispenser of claim 12 further comprising an air filter for filtering the air prior to the air flowing into the container.

14. The dispenser of claim 12 wherein the liquid pump potion includes a liquid piston for expanding and contracting the liquid chamber.

15. A dispenser comprising:
a rigid container for holding a liquid;
a pump secured to the container;
the pump having a liquid pump portion and an air pump portion;
the liquid pump portion having a one-way liquid inlet valve; a liquid pump chamber and a liquid outlet valve;
wherein expansion of the liquid chamber causes liquid to flow from the container past the liquid inlet valve into the pump chamber;
wherein compression of the liquid chamber causes liquid to flow from the pump chamber past the liquid outlet valve;
the air pump portion includes an air pump chamber, a piston, a one-way air inlet valve and a filter;
wherein compression of the air pump chamber causes air to flow through the filter and past the one-way air inlet valve into the container.

16. The dispenser of claim 15 further comprising a first cylindrical wall that forms at least a portion of the liquid pump portion and the air pump portion.

17. The dispenser of claim 15 wherein the filter is selected to filter bacteria from the air.

18. A dispenser comprising:
a rigid container for holding a liquid;
a pump secured to the container;
the pump having a liquid pump portion and an air pump portion;
the liquid pump portion having a one-way liquid inlet valve; a liquid pump chamber and a liquid outlet valve;
wherein expansion of the liquid chamber causes liquid to flow from the container past the liquid inlet valve into the pump chamber;
wherein compression of the liquid chamber causes liquid to flow from the pump chamber past the liquid outlet valve;
the air pump portion includes an air pump chamber, a piston and a filter;
wherein compression of the air pump chamber causes air to flow through the filter and into the container.

19. The dispenser of claim 15 further comprising a first cylindrical wall that forms at least a portion of the liquid pump portion and the air pump portion.

20. The dispenser of claim 15 wherein the filter is selected to filter bacteria from the air.
